(19) United States
(12) Patent Application Publication
(10) Pub. No.: US 2023/0033406 A1
(43) Pub. Date: Feb. 2, 2023

(54) TRAILER MOUNTED PORTABLE SOLAR POWER SUPPLY

(71) Applicant: Sayles, LLC, Lovelock, NV (US)

(72) Inventor: Charles O. Sayles, Lovelock, NV (US)

(21) Appl. No.: 17/387,796

(22) Filed: Jul. 28, 2021

(51) Int. Cl. H02S 10/40; H02J 7/35; H02S 30/20; H02S 20/30; H02S 40/32; H02S 10/10; H02S 40/38

(52) U.S. Cl. CPC H02S 10/40; H02J 7/35; H02S 10/10; H02S 20/30; H02S 30/20; H02S 40/32; H02S 40/38

(57) ABSTRACT

Trailer mounted portable solar power supplies disclosed can include lights and a backup generator. A solar array with solar panels can be connected to a 360 degree rotatable turntable mounted on a trailer frame enabling the capture of sunlight from all directions. A rotatable telescoping mast with mounted lights can be mounted to the trailer frame. Solar power supply systems can be configured with or without batteries. The AC voltage output can provide electricity for vehicles, homes, buildings, electric vehicles, etc. Portable solar power systems can implement multiple solar arrays to capture more sunlight and generate more electricity. The solar arrays and solar panels are foldable allowing the power system to be retracted for transport. The solar panels can also include sensors to control the positioning of the panels and turn the lights on and off by an onboard computer or wirelessly.

This is a Nonprovisional Utility U.S. Patent Application under 37 CFR 1.53(b).

### BACKGROUND OF THE INVENTION

### 1. Field of the Invention

The present invention relates generally to solar power supply systems and devices. More specifically, the invention is directed to the field of solar power supply systems with lights and backup generators.

### 2. Description of Related Art

A solar power system uses one or more solar panels to convert sunlight into electricity. Solar power systems consist of multiple components, including the photovoltaic modules, mechanical and electrical connections and mountings and means of regulating or modifying the electrical output. Solar power supplies have been supplying power to many fixed structures such as homes, buildings, and other structures. The solar panels can be placed on the roofs of these structures or at areas of land adjacent to the structures. This configuration works well with fixed buildings because the panels can be mounted and left indefinitely. However, in some applications, temporary or emergency electrical power may be needed. In order to solve this problem, what is needed is a standalone portable solar power system.

Stand-alone portable solar power systems have many uses. For example, road construction or maintenance is preferably done at night when traffic is low, and the effect on drivers and traffic is minimized. Other construction is performed during the night as well when deadlines or weather patterns dictate. At night construction sites large lights are used to illuminate the work area so that the workers are able to see. The large lights are usually high wattage lights which run using a diesel based generator, which can be expensive depending on the price of diesel. Tower lights are generally diesel powered, producing unwanted noise and pollution.

There is a need in the field for a portable solar power supply system that is easily transported on trucks or towed with a trailer hitch, which can provide reliable light.

### SUMMARY OF THE INVENTION

A system for providing a trailer mounted portable solar power supply is disclosed herein. A solar array with solar panels can be connected to a turntable mounted on a trailer frame. The solar array turntable can rotate 360 degrees to allow the solar panels to capture sunlight from any direction. A telescoping mast with lights can be connected to a turntable mounted on the trailer frame. The mast can rotate in all directions to provide light as needed. Solar power supply systems can be configured with or without batteries. In a solar power system with batteries, a solar charge controller can maintain a proper charging output voltage to the batteries. Inverters can convert voltage from the solar array or batteries into an AC voltage output. The AC voltage output can provide electricity for vehicles, homes, buildings, and other electrical devices. The AC voltage output can be configured with electrical components to function as an electric vehicle charging station.

Some solar power systems can implement multiple solar arrays to capture more sunlight and generate more (e.g. double) electrical energy. The solar arrays and solar panels are foldable which enables the power system to be retracted for transport. Solar panels can be folded or deployed and locked in place mechanically without actuators except to tilt and/or rotate the solar array. The solar panels can be oriented in different directions to change the size of the solar array. For example, the solar panels can be oriented horizontally, vertically, or a combination of horizontal/vertical. The solar panels can also include sensors to control the positioning of the panels and turn the lights on and off through an on-board computer or a computer connected through a wireless network.

These and other features and advantages will be apparent from reading of the following detailed description and review of the associated drawings. It is to be understood that both the forgoing general description and the following detailed description are explanatory and do not restrict aspects as claimed.

### BRIEF DESCRIPTION OF THE DRAWINGS

FIG. 1 illustrates a front view of a standalone portable solar power supply system with a telescoping mast extended.

FIG. 2 illustrates the solar power supply system retracted and ready for transport.

FIG. 3 illustrates a rear view of the solar power supply system with the telescoping mast partially extended.

FIG. 4 illustrates a side view of the solar power supply system with no telescoping mast.

FIG. 5A illustrates a top view of a turntable.

FIG. 5B illustrates a front view of a turntable.

FIG. 6 illustrates a schematic energy flow diagram of the portable solar power supply system.

### DETAILED DESCRIPTION OF THE INVENTION

The following descriptions relate principally to preferred embodiments while a few alternative embodiments may also be referenced on occasion, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more. Thus, in the context of this specification, the term “comprising” is used in an inclusive sense and thus should be understood as meaning “including, but not limited to.” As used herein, the use of “may” or “may be” indicates that a modified term is appropriate, capable, or suitable for an indicated capacity, function, or usage, while considering that in some circumstances the modified term may sometimes not be appropriate, capable, or suitable. “Plurality” is defined as more than one when used to describe a quantity in the description and claims.

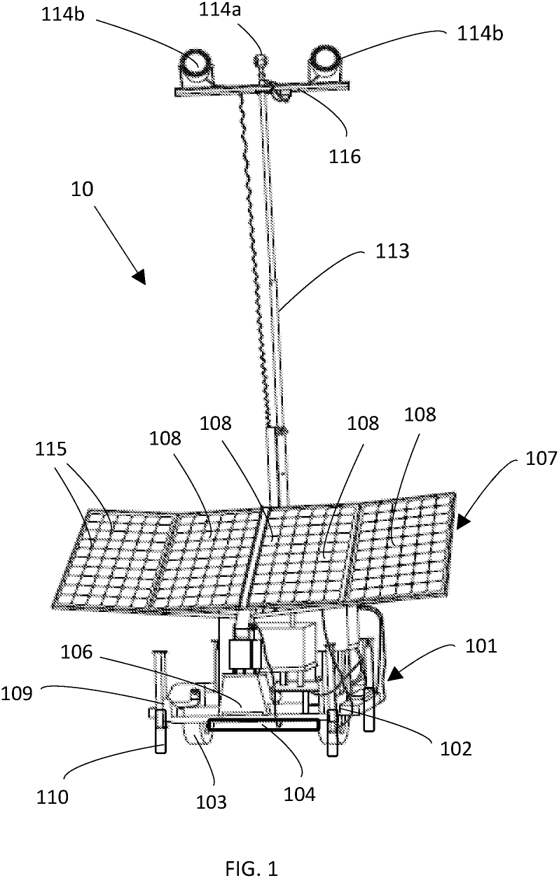

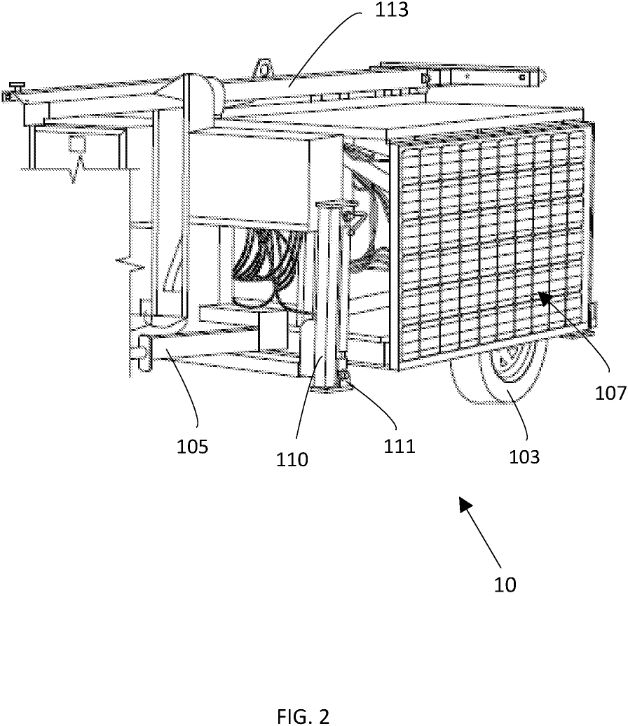

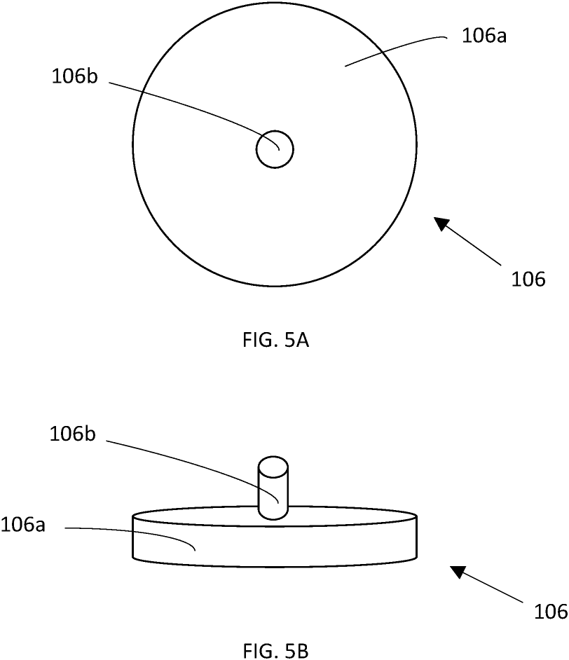

FIG. 1 illustrates a front view of a standalone portable solar power supply system 10 with a telescoping mast 113 extended. The solar power supply 10 does not require a connection to an electric power grid. The solar power system 10 includes a trailer 101 with a trailer frame 102, a plurality of wheels 103, and at least one axle 104. The trailer 101 shown has one axle 104 that connects two wheels 103 enabling the wheels 103 to rotate. With reference to FIG. 2, the trailer 101 also includes a trailer hitch 105. A turntable 106 (also shown in FIG. 5) can be mounted to the trailer frame 102. A solar array 107 with a plurality of solar panels 108 can be mounted to the solar array turntable 106. The turntable 106 is rotatable 360 degrees enabling the solar array 107 to rotate toward the direction of the sun, regardless of the orientation of the trailer 101. The trailer 101 can include an outrigger 109 at each corner that can be pulled out manually or have mechanical assistance for extending and retracting. Each outrigger 109 can include a stabilizing jack 110 with a drop foot 111 (shown in FIG. 2). The stabilizing jacks 110 can be lowered to stabilize the solar power system 10 on the ground, as depicted in FIG. 1. Further, the jacks 110 can be rotated for ground clearance to transport the power system 10.

The solar panels 108 include a plurality of photovoltaic (PV) cells for capturing energy from the sun and converting it to electrical energy. A plurality of light emitting diodes (LEDs) 115 can be mounted to the solar array 107 for providing illumination to the solar panels 108. Further, the LEDs 115 on the solar array can illuminate the trailer hitch 105 so the process of backing up and connecting the hitch 105 is easier and improves nighttime safety. The solar array 107 and solar panels 108 are foldable enabling the power system 10 to be retracted for transport. Solar panels 108 can be folded or deployed and locked in place mechanically without actuators except to tilt and/or rotate the solar array 107. The solar panels 108 can be oriented in different directions to change the size of the solar array 107. For example, the solar panels 108 can be oriented horizontally, vertically, or a combination of horizontal/vertical. The particular orientation of the solar panels 108 will affect the size (surface area) of the solar array 107. The solar power system 10 can further include an air bag suspension system which allows the axle 104 to lift the wheels 103 above the ground. The air bag suspension system can utilize a 12-Volt or 24-Volt compressor. In other embodiments, two or three axles 104 can be implemented. The trailer 101 can use heavy duty axle- less suspension to help with ground clearance until the weight of the trailer 101 and solar power system 10 exceeds a weight limit. When the weight limit is exceeded, one or more axles 104 and wheels 103 are utilized. The trailers 101 can be equipped with brakes and lights in compliance with Department of Transportation regulations if used on the roads.

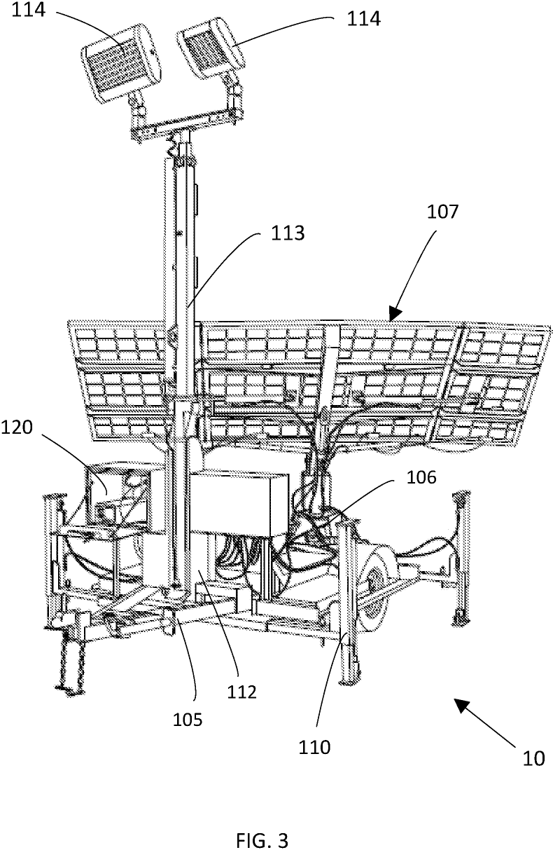

Further, the solar power system 10 can include a telescoping mast 113. A mast turntable 112 (shown in FIG. 3) can be mounted to the trailer frame 102. The telescoping mast 113 can be mounted to the turntable 112. A plurality of LEDs 114 can be mounted to the telescoping mast 113. As one example, the LEDs can be dimmable Stadium lights using 175 lumens per watt led chips and a custom thirty-degree light angle lens with an IP66 rating. A cross arm 116 mounted on top of the mast 113 can hold a fixed light 114a in the center and two adjustable lights 114b. The adjustable lights 114b can include pipe nipples welded on each end to hold antennas for wireless radios. The telescoping mast 113 can include a first nested section extended and retracted with a mechanical device, linear actuator, screw jack or winch. The rest of the nested sections can extend and retract with a wire rope and pully arrangement. The mast turntable 112 and solar array turntable 106 can be locked in place with any mechanical device and a spring latch engaged in one of the pre-drilled holes. The mast turntable 112 is rotatable 360 degrees enabling the LEDs 114 to provide light in different directions as needed.

The position of the LEDs 114 on top of the mast 113 is controlled by momentary switches or wireless relays that control the electrical devices for positioning up/down and sideways. Other types of lights can be implemented in place of LEDs 114. The telescoping mast 113 is implemented in power systems with lighting but is not required in systems designed only to generate electric power. The solar panels 108 in the center of the solar array 107 are spread apart far enough to allow the telescoping mast 113 to pass through the center. The array 107 can rotate around the telescoping mast 113 while the mast 113 can rotate independently inside the array 107.

In systems requiring additional power, a second turntable can be mounted to the trailer frame 102. A foldable second solar array with a plurality of solar panels 108 can be mounted to the second turntable. For example, adding a second solar array can enable the system to capture more sunlight and generate more (e.g. double) electrical energy. In this alternative embodiment, the trailer frame 102 would be larger and expandable. While the solar power system is in use, a trailer portion with the second solar array could be extended so that the first and second solar arrays can rotate without impeding each other. The extendable portion can have outriggers and jacks for stabilizing and leveling. Further, the extendable trailer portion can be retracted to allow transport of the power system. The extendable trailer could supply electric power of 120 Volts AC up to 240 Volts AC. By, for example, adding 2 further additional arrays, the system of the present invention could further supply electric power up to 480 Volts AC. The system of the present invention could further supply DC power.

FIG. 2 illustrates the solar power supply system 10 retracted and ready for transport. The solar arrays are retracted and folded to the sides of trailer 101. The telescoping mast 113 is retracted and folded on top of the power supply 10. The trailer 101 includes a trailer hitch 105 which can be connected to a truck or other vehicle for towing. The outriggers 109 with stabilizing jacks 110 are retracted and off the ground during transport. In an alternative embodiment, the solar power system 10 can be placed (mounted) on skids. If mounted on skids, the trailer 101 would not require wheels because the skids can support the weight of the trailer 101 and keep the power system 10 above the ground.

FIG. 3 illustrates a rear view of the solar power supply system 10 with the telescoping mast 113 partially extended. The outriggers 109 with jacks 110 and feet are lowered to the ground to stabilize the solar power system 10. The solar panels 108 can also include sensors to control the positioning of the panels 108 and turn the lights on and off through an on-board computer or a computer connected through a wireless system. The same computer can be used to control solar charge controller(s) and inverter(s) plus any other attachments or options. A control box 120 can be mounted on slides, an extendable square tube, or other mechanism that allows the control box 120 to be pulled out away from the trailer far enough for the operator to be clear of the folding solar panels 108 while operating the controls. An LED light bar with motion control can be installed inside the control box 120 to illuminate controls in low visibility. The control box 120 can be controlled manually or remotely. The power supply system 10 can optionally include features implemented in travel trailers and recreational vehicles, such as level controls and indicators. Further, the system 10 can include automated outriggers and stabilizing jacks to extend and self-level.

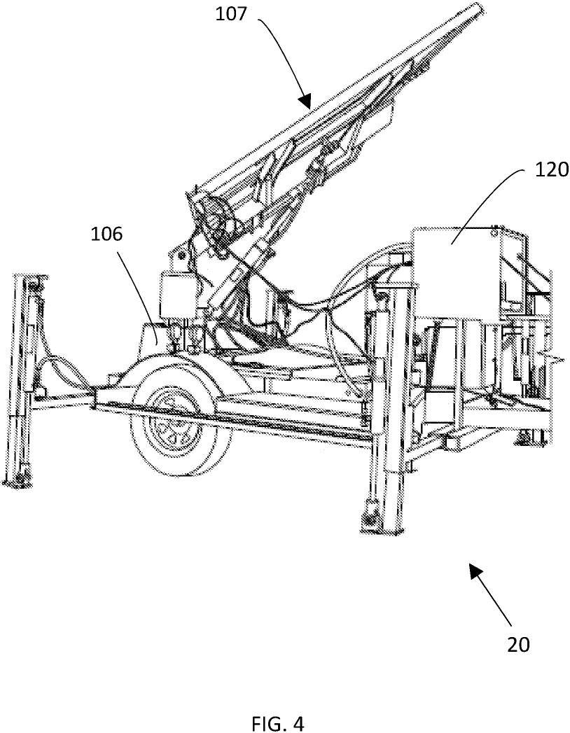

FIG. 4 illustrates a side view of the solar power supply system 20. In this power supply embodiment 20, there is no telescoping mast. The power supply 20 converts solar energy to electrical power but does not serve as a light source. Solar power supply systems can be built to customer specifications and offer multiple options. For example, options can include lasers for ground control monitoring, ground control radar, cameras, radios (e.g. Rajant products), and Cisco® for the site wireless network.

FIG. 5A and FIG. 5B illustrate a solar array turntable 106 that can be implemented in solar power supply systems 10, 20. The turntable 106 includes a base 106a and a connector 106b. The mast turntable 112 can be configured similarly to the array turntable 106 with the same components to enable connection of the telescoping mast 113. The turntable 106 can be mounted to the trailer frame 102 using fasteners. As shown in FIG. 1, a solar array 107 can be mounted to the turntable 106 at the connector 106b. The turntable 106 can rotate 360 degrees which allows the solar array 107 to face the direction of the sun. Turntables for the LED lights, telescoping mast 112 and solar array 106 are supported with transfer ball bearings. The turntables 106, 112 can be turned manually or with linear actuators, rack and spur gears connected to linear actuators, or gear driven with motors. Other means of rotating turntables include: ring gear and pinion motor driven, motor and gear reducers, motor with chain and sprocket, or motor and belts. The mast turntable 112 and solar array turntable 106 can be locked in place with any of the mechanical devices and a spring latch engaged in one of the pre-drilled holes.

The turntable 106 can be rotated by a user operating controls for manual solar tracking. Alternatively, the solar array 107 can rotate using passive trackers (e.g. low boiling point compressed gas) or active trackers (e.g. light sensors, date/time based algorithms). Preferably, solar power systems 10, 20 employ dual axis solar trackers enabling the solar array 107 to move along north-south and east-west axes.

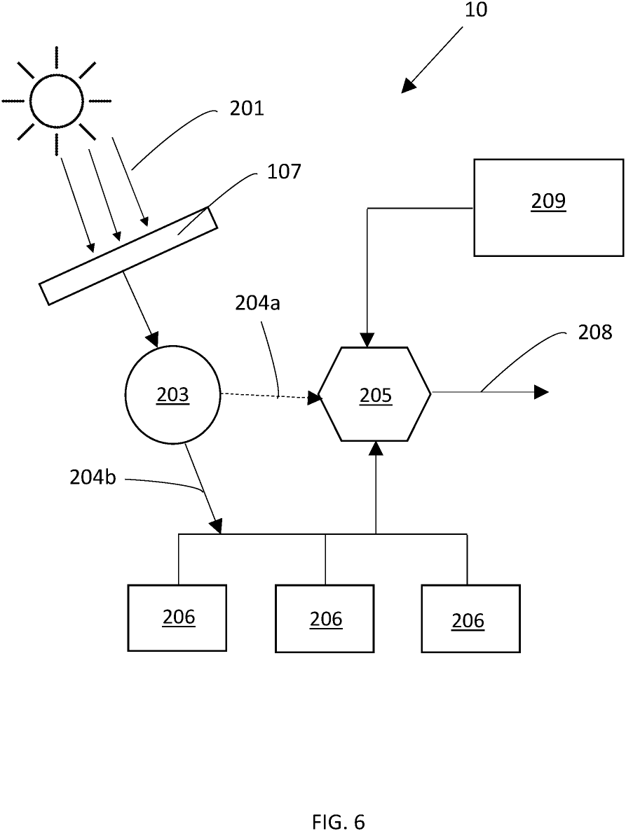

FIG. 6 illustrates a schematic energy flow diagram of the portable solar power supply system 10. Sunlight energy 201 is captured by the solar panels 108 of the solar array 107. A voltage regulator 203 is electrically connected to the solar array 107 and produces a stable output voltage 204a over a range of input voltages 202. In a power system 10 without batteries for energy storage, the voltage regulator 203 can control the output voltage 204a which flows to an inverter 205 during daylight operating times.

In a power system with a plurality of batteries 206, the voltage regulator 203 can be a solar charge controller 203. The input voltage 202 received from the solar array 107 can vary greatly and be very high during times of greater sunlight. High voltages can damage the batteries 206 and a charge controller 203 is used to maintain a proper charging output voltage 204b to the batteries 206. As the input voltage 202 from the solar array 107 increases, the charge controller 203 regulates the output voltage 204b to the batteries 206 to prevent excessive charging. Further, the solar charge controller 203 can also prevent battery damage that can result from excessive discharging.

The batteries 206 can be located in various locations around the trailer 101. The batteries 206 can be located on the deck of the trailer 101. Alternatively, the batteries 206 can be located in a large compartment with part of the compartment below the trailer frame 102 to act as a low ballast to stabilize the trailer 101 in high wind conditions. Another concept is to place the solar array 107 at the back of the trailer 101 on a turntable 106 with the batteries 206 located in the middle of the trailer 101. The batteries 206 can be mounted on top of the trailer frame 103 or recessed down into the frame 103 to improve the clearance above and lower the center of gravity for more stability in windy conditions. If the solar array 107 is at the back of the trailer 101, the telescoping mast would be mounted on a turntable 112 at the front of the trailer to provide adequate clearance for the solar panels 108 when the array 107 is unfolded (deployed).

The charge controller 203 can employ Maximum Power Point Tracking (MPPT) or Pulse Width Modulation (PWM). An MPPT controller can match the output of the solar panels to the battery voltage to ensure maximum charge (amps). A MPPT controller can deliver increased current if the battery voltage is below an optimum value. Thus, an MPPT controller is always able to output an optimum charging power to a battery 206. In contrast, a PWM controller uses metal-oxide-semiconductor field-effect transistors (MOSFET) or power transistors at high frequencies to pulse the charge current on and off in order to maintain a constant battery voltage. PWM controllers often have three stage charge cycles such as bulk, absorption, and float. The charge controller 203 constantly checks the battery voltage to determine how fast to send pulses, and the length of the pulses. In a fully charged battery 206 with no load (float), it may just send a short pulse to the battery 206 every few seconds or longer. In a discharged battery 206 (bulk), the pulses would be very long and almost continuous. When the bulk level voltage is reached by the batteries 206, the absorption stage begins. During the absorption stage, the battery voltage can be maintained at bulk voltage level for a specified time while the current gradually tapers off as the batteries charge up. The charge controller 203 checks the state of charge (battery voltage) between pulses and adjusts as needed.

The electric power generated by the solar array 107 is stored in a plurality of batteries 206. The batteries 206 can preferably be lithium-ion batteries or lead acid batteries. The lead acid batteries can be absorbed glass mat (AGM) batteries or gelled batteries. The power supply system 10 is preferably designed to be environmentally friendly. In other embodiments, other types of rechargeable batteries can be implemented such as fuel cells. The batteries 206 are electrically connected to the inverter 205. Direct current (DC) voltage 202 produced from the solar array 107 and stored in batteries 206 can be transferred to the inverter 205 to convert the DC voltage into alternating current (AC) voltage output 208. For example, the solar array 107 can produce 48 volt DC and the batteries 206 can store the 48 volt DC. The inverter 205 can convert the 48 volt DC from the array 107 or batteries 206 into the AC output 208. The inverter 205 can convert 48 volt DC into 120 volt AC or 240 volt AC. The AC voltage output 208 can provide electricity for vehicles, homes, buildings, and other electrical devices. The AC voltage output 208 can be configured with electrical components to function as an electric vehicle charging station. Multiple inverters, charge controllers, and battery strings can be implemented in alternative embodiments.

A backup electric power (energy) generator 209 can be implemented and electrically connected to the solar power system 10. For example, the electric power generator 209 can be a diesel generator, a gasoline generator, a natural gas generator, a fuel cell generator, etc. A backup generator 209 is very useful for supplying power in times of poor solar charging, such as during the night or on cloudy days. In addition, the backup generator 209 ensures power can continue to be produced even if the solar power system 10 is temporarily shut down for maintenance. An auxiliary fuel tank can be mounted near the backup generator 209 to supply fuel if necessary to extend run time.

The portable solar power system 10 can be modular, enabling a plurality of portable solar power systems to be electrically connected together to generate a desired power output. For example, solar arrays 107 from different power systems 10, 20 can be connected in series or parallel depending on the needs for the system. Those of ordinary skill in the art know that when solar arrays 107 are wired in series, the voltage of the arrays adds together, but the current (amperage) remains the same. Wiring solar panels in parallel causes the amperage to increase, but the voltage remains the same. Since power is the product of voltage and current, connecting multiple arrays 107 in parallel or in series will increase power output.

There are many different material choices and other features that can be implemented in solar power systems 10, 20. For example, the fenders of the trailer 101 can be made from heavy tread plate for extreme durability and as a platform stand for a user. Bolts and other fasteners can be stainless steel while light mounts and turntables can be constructed from aluminum. The trailer hitch 105 can include heavy duty lunette rings, a “pintle hitch”, a ball hitch, or other types of hitches. A weld on u-shaped device allows the ring to be raised and lowered by changing the position of two heavy bolts. The power system 10 can also include an adapter to allow the installation of a ball hitch using the same u-shaped weld on device. Further, heavy insulation can be installed around the inside of battery enclosures. Air vents above the insulation and holes below the insulation allow any moisture to escape as well as meet the ventilation requirements for battery charging stations.

Cooling fans can be implemented to cool the heat generated by the charge controllers, inverters, batteries, and hot weather environments. Further, heat and more insulation can be added for the battery enclosures in cold weather locations. Guy wires and anchors can be included for stability in windy environments. Transformers can be used to convert to different energy requirements, whether there is a need for increased or decreased energy.

What is claimed is:

1. A portable solar power system comprising:
a. a trailer including a trailer frame, a trailer hitch, a plurality of wheels, and at least one axle;
b. a first turntable operatively connected to the trailer frame;
c. the first turntable is rotatable 360 degrees;
d. a first solar array mounted on the first turntable;
e. the first solar array includes a plurality of solar panels;
f. the plurality of solar panels includes a plurality of photovoltaic cells;
g. at least one voltage regulator coupled to the plurality of solar panels;
h. at least one inverter coupled to the at least one voltage regulator for converting DC power to AC power;
i. an electrical outlet coupled to the at least one inverter for providing AC power to electrical devices;
j. the plurality of solar panels of the first solar array are foldable;
k. the plurality of solar panels of the first solar array can be oriented in different directions to change the size of the first solar array; and
l. an air bag suspension system enabling the at least one axle to lift the plurality of wheels above the ground.

2. The system of claim 1, further comprising:
a. a second turntable operatively connected to the trailer frame;
b. the second turntable is rotatable 360 degrees;
c. a telescoping mast mounted on the second turntable;
d. a second solar array mounted on the second turntable;
e. the second solar array includes a plurality of solar panels;
f. the plurality of solar panels of the second solar array are foldable; and
g. the plurality of solar panels of the second solar array can be oriented in different directions to change the size of the second solar array.

3. The system of claim 1, wherein the plurality of solar panels of the first array can be deployed and locked in place mechanically without using actuators.

4. The system of claim 1, wherein the portable solar power system is modular, enabling a plurality of portable solar power systems to be electrically connected together to generate a desired power output.

5. The system of claim 1, further comprising a plurality of light emitting diodes mounted to the first solar array.

6. The system of claim 1, further comprising:
a. a second turntable operatively connected to the trailer frame;
b. the second turntable is rotatable 360 degrees;
c. a telescoping mast mounted on the second turntable; and
d. a plurality of light emitting diodes mounted to the telescoping mast.

7. The system of claim 1, further comprising:
a. a battery system for storing electric power generated by the portable solar power system;
b. wherein the at least one voltage regulator is a solar charge controller;
c. the solar charge controller is further coupled to the battery system; and
d. wherein the solar charge controller monitors and controls charging of the battery system.

8. The system of claim 1, wherein the trailer includes three axles.

9. The system of claim 1, further comprising electrical components enabling an electric vehicle to charge by connecting to the portable solar power system.

10. The system of claim 1, further comprising a backup electric power generator.

11. The system of claim 10, wherein the backup electric power generator is at least one of: a diesel generator, a gasoline generator, a natural gas generator, and a fuel cell generator.

12. A portable solar power system comprising:
a. a trailer including a trailer frame, a trailer hitch, and at least one axle;
b. at least one skid to support the trailer;
c. a first turntable operatively connected to the trailer frame;
d. the first turntable is rotatable 360 degrees;
e. a first solar array mounted on the first turntable;
f. the first solar array includes a plurality of solar panels;
g. the plurality of solar panels includes a plurality of photovoltaic cells;
h. at least one voltage regulator coupled to the plurality of solar panels;
i. at least one inverter coupled to the at least one voltage regulator for converting DC power to AC power;
j. an electrical outlet coupled to the at least one inverter for providing AC power to electrical devices;
k. the plurality of solar panels of the first solar array are foldable; and
l. the plurality of solar panels of the first solar array can be oriented in different directions to change the size of the first solar array.

13. The system of claim 12, further comprising:
a. a second turntable operatively connected to the trailer frame;
b. the second turntable is rotatable 360 degrees;
c. a telescoping mast mounted on the second turntable;
d. a second solar array mounted on the second turntable;
e. the second solar array includes a plurality of solar panels;
f. the plurality of solar panels of the second solar array are foldable; and
g. the plurality of solar panels of the second solar array can be oriented in different directions to change the size of the second solar array.

14. The system of claim 12, wherein the plurality of solar panels of the first array can be deployed and locked in place mechanically without using actuators.

15. The system of claim 12, wherein the portable solar power system is modular, enabling a plurality of portable solar power systems to be electrically connected together to generate a desired power output.

16. The system of claim 12, further comprising a plurality of light emitting diodes mounted to the first solar array.

17. The system of claim 12, further comprising:
a. a second turntable operatively connected to the trailer frame;
b. the second turntable is rotatable 360 degrees;
c. a telescoping mast mounted on the second turntable; and
d. a plurality of light emitting diodes mounted to the telescoping mast.

18. The system of claim 12, further comprising:
a. a battery system for storing electric power generated by the portable solar power system;
b. wherein the at least one voltage regulator is a solar charge controller;
c. the solar charge controller is further coupled to the battery system; and
d. wherein the solar charge controller monitors and controls charging of the battery system.

19. The system of claim 12, wherein the trailer includes three axles.

20. The system of claim 12, further comprising electrical components enabling an electric vehicle to charge by connecting to the portable solar power system.

21. The system of claim 12, further comprising a backup electric power generator.

22. The system of claim 21, wherein the backup electric power generator is at least one of: a diesel generator, a gasoline generator, a natural gas generator, and a fuel cell generator.
